(19) United States
(12) Patent Application Publication
(10) Pub. No.: US 2026/0042328 A1
(43) Pub. Date: Feb. 12, 2026

(54) PLUG DEVICE FOR A PLUG-TYPE COUPLING SYSTEM BETWEEN A FIRST VEHICLE AND A SECOND VEHICLE

(71) Applicant: JOST-WERKE DEUTSCHLAND GMBH, Neu-Isenburg (DE)

(72) Inventors: José Manuel ALGÜERA, Aschaffenburg (DE); Swen SAUPE, Mainz (DE); Stephan GITZEN, Riedstadt (DE)

(21) Appl. No.: 18/877,566

(22) PCT Filed: Jun. 29, 2023
(86) PCT No.: PCT/IB2023/056786

§ 371 Date: Dec. 20, 2024

(30) Foreign Application Priority Data
Jul. 1, 2022 (DE) 10 2022 002 391.1

(51) Int. Cl. B60D 1/64

(52) U.S. Cl. CPC B60D 1/64

(57) ABSTRACT

A plug device for a plug-type coupling system between a first vehicle and a second vehicle. The plug device has a first plug half, which is paired with a first vehicle and which includes a first housing and a plurality of contact elements arranged in the housing, and a second plug half, which is paired with the second vehicle and which includes a second housing and a plurality of contact elements arranged in the second housing, wherein the contact elements on the first plug half are plug sockets and the contact elements of the second plug half are contact pins which contact the plug sockets when the first and second plug halves approach are brought together in a plug-in axis. At least one contact element is fitted in a plug element which is movably mounted in the plug-in axis with respect to the corresponding first or second housing.

### FIELD OF THE INVENTION

The invention relates to a plug device for a plug-type coupling system between a first vehicle and a second vehicle, wherein the plug device has a first plug half which is paired with the first vehicle and which comprises a first housing and a plurality of contact elements arranged in the first housing, and a second plug half which is paired with the second vehicle and which comprises a second housing and a plurality of contact elements arranged in the second housing, wherein the contact elements on the first plug half are plug sockets and the contact elements of the second plug half are contact pins which contact the plug sockets when the first and second plug halves are brought together in a plug-in axis (x), wherein at least one contact element is fitted in a plug element which is movably mounted in the plug-in axis (x) with respect to the corresponding first or second housing.

### BACKGROUND OF THE INVENTION

Plug-type coupling systems are now being installed between a towing vehicle, such as a tractor unit, and a trailer vehicle, such as a semi-trailer, in order to establish a largely or completely automated connection of the supply lines during the mechanical coupling process of the towing vehicle and trailer vehicle.

Document DE 10 2004 024 333 B4 describes a typical plug-type coupling system in which, as the towing vehicle approaches the trailer vehicle from behind, a first plug half arranged on the towing vehicle catches a second plug half mounted on the trailer vehicle so that it can pivot around a kingpin, and both plug halves are pushed into one another in contact as the towing vehicle approaches the trailer vehicle further.

Document DE 10 2018 117 584 A1 shows a plug-in device that is now widely used, but which has proven to be no longer sufficient with regard to the geometry and the number and assignment of the contact elements in the first and second plug halves due to increasing demands on the energy and data transfer between the towing vehicle and the trailer vehicle. In particular, it is necessary for future applications that the plug devices formed from the first and second plug halves are suitable for transmitting signals with an even higher transmission rate and transmission quality from the towing vehicle to the trailer vehicle.

However, this creates compatibility problems between the different generations of plug devices. Since not all towing vehicles and trailer vehicles will be equipped with the latest generation of plug devices at the same time, it must be ensured that the design and positioning of future plug halves cannot cause any mechanical or electrical damage or malfunctions, for example if a first plug half of the latest generation meets a second plug half of an older generation or vice versa.

Consequently, the invention was based on the object of further developing a plug device in such a way that it can be used to connect the first and second plug halves of the same or different generations without damage or malfunctions.

### SUMMARY OF THE INVENTION

The object is solved according to the invention with the features of a plug device for a plug-type coupling system between a first vehicle and a second vehicle, wherein the plug device has a first plug half which is paired with the first vehicle and which comprises a first housing and a plurality of contact elements arranged in the first housing, and a second plug half which is paired with the second vehicle and which comprises a second housing and a plurality of contact elements arranged in the second housing, wherein the contact elements on the first plug half are plug sockets and the contact elements of the second plug half are contact pins which contact the plug sockets when the first and second plug halves are brought together in a plug-in axis (x), wherein at least one contact element is fitted in a plug element which is movably mounted in the plug-in axis (x) with respect to the corresponding first or second housing wherein the plug element is provided in such a way that, in the case of a collision of the first or second plug half with components of another, geometrically incompatible second or first plug half, the plug element is arranged such that it can yield in the plug-in axis (x) counter to the plug-in direction and releases an assembly space, into which a portion of the other, incompatible second or first plug half can enter, wherein the plug element is oriented reversibly in a pushed-back yielding position (x₂) without a connection of the contact elements. The older plug devices on the market with first and second plug halves of the same generation are compatible with each other in terms of their functional and geometric properties. The same applies to the latest generation of first and second plug halves, which are also compatible with each other. However, problems can arise if, for example, a first vehicle is equipped with a first plug half of the latest generation and a second vehicle to be coupled to it is equipped with a second plug half of an older generation. In this case, it would be acceptable if the range of functions were limited to the functionality of the second plug half. However, it must be avoided that mechanical damage to one or both of the first and second plug halves occurs due to geometric incompatibility when such first and second plug halves from different generations are used together.

Destruction during the coupling of a geometrically incompatible first and second plug half is avoided by at least one contact element being mounted in a plug element that is movably mounted in the plug-in axis with respect to the associated first or second housing. In the event of a collision of the first or second plug half with components of another, geometrically incompatible second or first plug half, the plug element is arranged in the plug-in axis so that it can yield against the plug-in direction and releases an assembly space into which a portion of the other, incompatible second or first plug half can enter. The plug element is designed in such a way that when the first or second plug half makes contact with a geometrically incompatible second or first plug half, the plug element is reversibly aligned in a pushed-back yielding position without a connection of contact elements. The plug element only yields when it makes contact with a geometrically incompatible first or second plug half. When the first or second plug half is contacted with a geometrically compatible second or first plug half, a provided, conductive or transmitting connection of the contact elements involved is established in an initial position of the plug element.

A contact element is understood to be a detachable transmission point for electrical and/or pneumatic and/or hydraulic energy, which is typically designed as a classic plug/socket. This in turn can have contact plates arranged radially or in the plug-in axis on the front or contact tongues that lie against one another in a connected state. The plug/socket is in particular also a coaxial plug that interacts with a coaxial plug socket.

The plug element is preferably guided linearly with respect to the associated first or second housing. Such linear guidance can be achieved by inserting the plug element into a complementarily shaped recess in the first or second housing.

According to a first advantageous embodiment, the plug element is a section of the first or second housing. This section of the first or second housing is mounted so that it can move relative to the remaining, relatively stationary part of the housing. This embodiment offers the advantage that several contact elements can be accommodated in the section of the first or second housing and can be moved synchronously with one another.

The section of the first or second housing can in particular be formed from a part of the front wall facing the other second or first housing. The front wall usually carries the contact elements of the first or second housing. If the respective plug element yields in the plug-in axis, the part of the front wall also migrates into the interior of the contour originally spanned by the first or second housing.

The contact element is expediently arranged so that it is in a fixed position relative to the section of the associated first or second housing. This can be achieved in particular by attaching the respective contact element to the section of the first or second housing. It makes sense for one of the several plug sockets to be attached to the section of the associated first housing.

According to a second advantageous embodiment, the plug element is one plug socket of the plurality of plug sockets. In this embodiment, only at least one of the plug sockets is mounted in the plug-in axis so that it can move relative to the first housing. The wall sections of the first housing, on the other hand, are arranged in a fixed position relative to one another. Reducing the movable mounting to the plug socket enables a particularly compact design, since no free installation space needs to be taken into account for moving parts of the first or second housing.

Preferably, one of the plug sockets of the plug element is arranged such that it is opposite the contact pin that protrudes furthest in the plug-in axis. In this area, a collision between the first and second plug halves would first occur.

One contact pin of the plurality of contact pins is advantageously fastened to the section of the associated second housing. In this embodiment, as an alternative to the plug socket, one or more of the contact pins is/are movably mounted in the plug-in axis and can move out of the collision area as a section of the second housing if the first and second plug halves are incompatible.

According to a third advantageous embodiment, the plug element is one contact pin of the plurality of contact pins. This embodiment also reduces the movably mounted part of the plug element to the smallest structural unit, namely the contact pin. Due to the omission of a movable mounting of a section of the second housing, particularly compact installation space dimensions can be achieved.

Advantageously, the one of the contact pins of the plug element is dimensioned in the plug-in axis such that it protrudes furthest from the second plug half. This results in initial contact being made at the furthest protruding contact pin, which then initially provides radial guidance for the first and second plug halves and is protected against damage due to its movable bearing in the axial direction.

It has proven to be particularly useful if the plug element is held in an extended initial position by means of a spring element or actuator. This means that the plug element always assumes a defined, extended initial position without the presence of another first or second plug half.

It can be particularly useful if the spring element or actuator transmits a preload force to the plug element that is greater than the plug resistance of a compatible contact element of the other first or second plug half. The plug resistance is understood to be the force occurring in the axial direction to connect compatible first and second plug halves. Such a connection is ensured by an appropriately stiff spring element or actuator, without the plug element unintentionally moving back. Even when driving, the plug element and contact element of the other first or second plug half should be pressed against each other with a constant preload force so that vibrations during driving do not interrupt the contact between the plug element and the contact element.

Preferably, the plug element is arranged in the first plug half and, when it comes into contact with an incompatible second plug half, is pushed into a pushed-back yielding position by the latter. Alternatively, it can also be provided that the plug element is arranged in the second plug half and, when it comes into contact with an incompatible first plug half, is pushed into a pushed-back yielding position by the latter.

According to a special embodiment, the plug element of the first plug half can have a travel path between an extended initial position and a pushed-back yielding position that corresponds to at least a difference between a length of the associated contact pin of the second plug half protruding from the second housing and a length of the associated plug socket of the plug element of the first plug half protruding into the first housing in its extended initial position. This results in the advantage that the travel distance is sufficiently large to avoid a destructive collision of the contact pin in the plug socket.

Alternatively, the plug element of the second plug half can also have a travel path between an extended initial position and a pushed-back yielding position, which corresponds to at least a difference between the length of the associated plug socket of the first plug half projecting into the first housing and a length of the associated contact pin of the plug element of the second plug half projecting from the second housing in its extended initial position. This also ensures that a sufficiently dimensioned travel path is always available and that a destructive collision of the contact pin with the plug socket is excluded.

The plug socket or the contact pin of the plug element preferably have transmission means that are arranged in and transversely to the plug-in axis outside a joint zone with the contact elements of the other, second or first housing. A joint zone is understood to be the area of the initial meeting of the plug socket and contact pin. The respective transmission means is always present on both contact elements of the first and second plug halves and is spatially arranged in such a way that contact can be made between the contact pin and the plug socket.

### BRIEF DESCRIPTION OF THE DRAWINGS

For a better understanding, the invention is explained in more detail below with reference to 13 Figures showing in

FIG. 1: a perspective view of a first plug half with a plug element according to a first embodiment;

FIG. 2: a perspective view of a second plug half with a plug element according to a first embodiment;

FIG. 3: a perspective view of a first plug half with a plug element according to a second embodiment;

FIG. 4: a perspective view of a second plug half with a plug element according to a second embodiment;

FIG. 5: a schematic cross section of a plug device before contacting with the first plug half of the latest generation and the second plug half of the latest generation comprising a plug element;

FIG. 6: a schematic cross section of a connected plug device with the first and second plug halves of an older generation;

FIG. 7: a schematic cross section of a plug device before contacting with the first plug half of the latest generation without a plug element and the second plug half of an older generation;

FIG. 8: a schematic cross-section according to FIG. 7 with damaging collision of the plug device during further approach;

FIG. 9: a schematic cross-section of a plug device after contact with the first plug half of the latest generation, having a plug element according to the first embodiment and the second plug half of the older generation;

FIG. 10: a schematic cross-section of a plug device after contact with the first plug half of the latest generation, having a plug element according to the second embodiment and the second plug half of the older generation;

FIG. 11: a schematic cross-section of a plug device before contact with the first plug half of the older generation and the second plug half of the latest generation, having a plug element according to the first embodiment;

FIG. 12: a schematic cross-section of a plug device according to FIG. 11 after contact;

FIG. 13: a schematic cross-section of a plug device after contact with the first plug half of the older generation and the second plug half of the latest generation having a plug element according to the second embodiment.

### DETAILED DESCRIPTION OF THE INVENTION

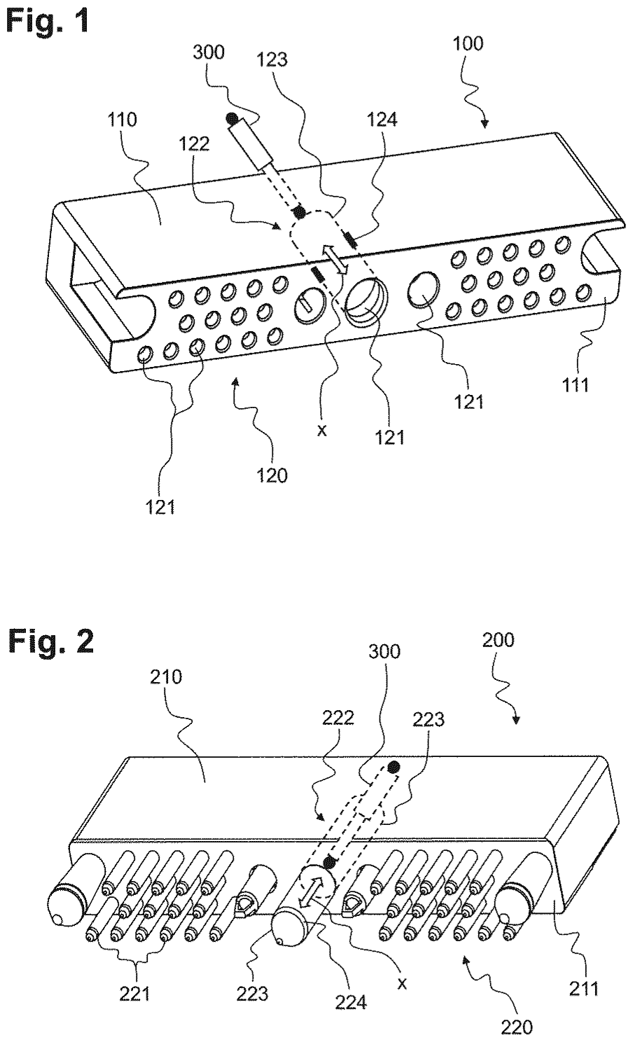

FIG. 1 shows a perspective view of a first plug half 100 according to a first embodiment. The first plug half 100 has a box-shaped first housing 110 with which the first plug half 100 is attached to a vehicle, in particular to a towing vehicle not shown here.

In a front wall 111 of the first housing 110, a plurality of contact elements 120 are provided in the form of openings in the front wall 111, which accommodate plug sockets 121 located behind them. The front wall 111 of the first housing 110, in the contacted state with a second plug half 200, is opposite a corresponding front wall 211 of its second housing 210 (see FIG. 7).

The plug sockets 121 serve to transmit electrical and pneumatic energy from the first vehicle (not shown) to a second vehicle coupled to it, wherein the electrical transmission includes the transmission of electrical control signals in addition to the actual energy supply. Depending on the intended use, the plug sockets 121 have different diameters, installation depths and transmission means 224 arranged therein for electrical and/or pneumatic contacting of the first and second plug halves 100, 200.

In the illustration according to FIG. 1, the middle plug socket 121 is movably mounted as a plug element 122 relative to the first housing 110 in a plug-in axis x. The plug element 122 is formed by the plug socket 123. Unlike the other plug sockets 121 of the first housing 110, the plug socket 123 can move backwards from the front wall 111 of the first housing 110 if an incompatible contact pin 221, for example, a second plug half 202 of an older generation (see FIG. 9, FIG. 10) is brought close to a first plug half 101 of the latest generation according to FIG. 1 and makes contact with it.

A spring element or actuator 300 is fixed with its first end to the plug socket 123 and with its second end to the first housing 110, so that the plug socket 123 is pressed towards the front wall 111 and is held there without the presence of the second plug half 200. The plug socket 123 of the plug element 122 is in a maximally extended initial position x₁ (see FIG. 9).

When the first plug half 100 is contacted with the contact element 220 of a compatible second plug half 200, in particular a second plug half 201 of the latest generation, its contact element 220 in the form of a fixed contact pin 221, which is shaped complementarily to the plug socket 123, pushes into the plug socket 123, whereby a connection is established between the first plug half 100, 101 and the second plug half 200, 201 when it approaches further in its end position.

The spring element or actuator 300 is designed in terms of its spring force or restoring force in such a way that when the first plug half 100 is connected to a compatible second plug half 200, the plug socket 123 does not deviate in the plug-in axis x and a contact pin 221 is connected to the plug socket 123 arranged in the plug element 122.

In the movably mounted plug socket 123 of the first plug half 100, transmission means 124 are arranged set back, in particular in the peripheral wall of the plug socket 123, in such a way that when connected to a non-compatible second plug half 200, in particular a second plug half 202 of an older generation, they lie outside a collision zone in which the transmission means 124 are caught and destroyed by the contact pin 221 of the second plug half 202 as it approaches.

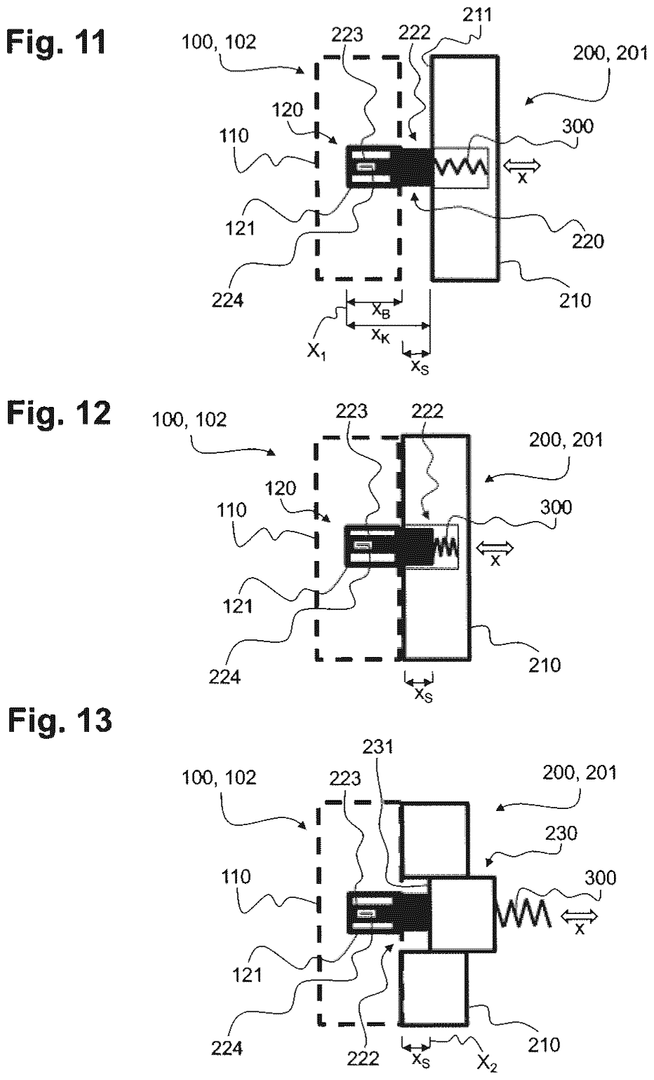

As an alternative to a plug socket 123 movably mounted in the plug-in axis x, it is also possible, according to FIG. 2, to design the contact pin 223 projecting further than the contact pins 221 on the second plug half 200 with respect to the front wall 211 as a plug element 222 that is movable with respect to the second housing 210. The front wall 211 is the wall of the second housing 210, which is opposite the front wall 111 of the first housing 110. In this case, the contact pin 223 of the plug element 222 moves back in the plug-in axis x when approaching an incompatible first plug half 100 after contacting within the associated plug socket 121. Without contact with an incompatible plug socket 121, the contact pin 223 is held in a maximum extended initial position x₁ with respect to the front wall 211 by means of the spring element or actuator 300 (see FIG. 11). The spring element or actuator 300 engages with one end on the contact pin 223 of the plug element 222 and with its other end on the second housing 210.

In this embodiment, too, the spring force or restoring force of the spring element or actuator 300 is designed such that a reliable connection of a compatible first and second plug halves 100, 200 is possible without the movably mounted contact pin 223 of the plug element 222 moving backwards. Only with an even higher pressure force, such as occurs when the contact pin 223 of the plug element 222 is joined to a plug socket 121 of an incompatible, first plug half 102 of an older generation, does this force allow the movably mounted contact pin 223 of the plug element 222 to move along the plug-in axis x into the second housing 210. The section of the contact pin 223 that protrudes from the front wall 211 of the second housing 210 in the direction of the first plug half 100 is shortened accordingly.

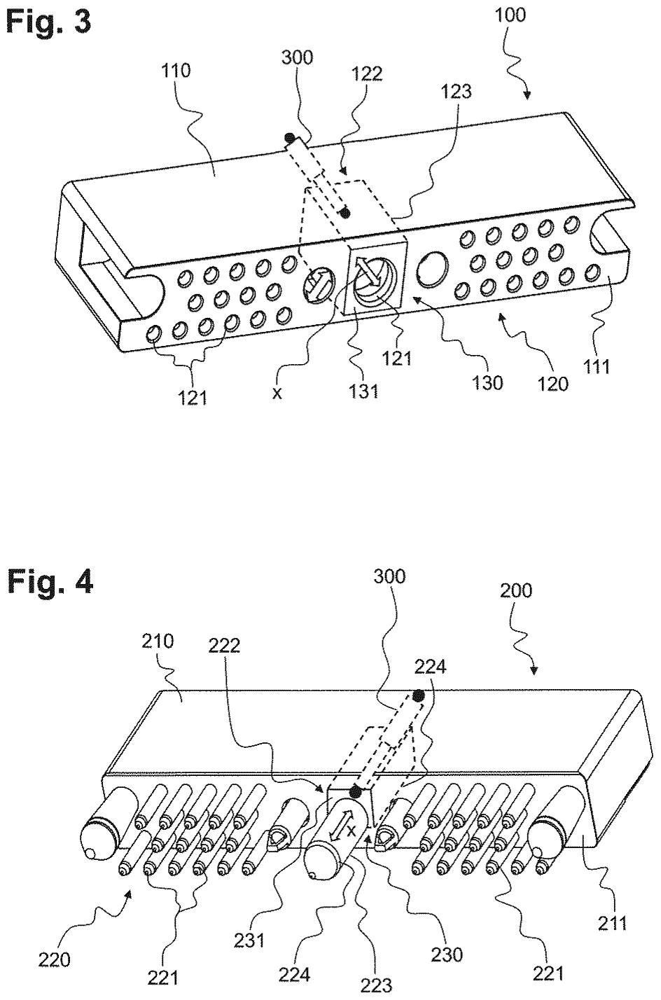

FIG. 3 shows an alternative embodiment of the first plug half 100, in which, unlike the embodiment of FIG: 1, not only the plug socket 123 is movably mounted as a displaceably mounted plug element 122 in the plug-in axis x, but also a section 130 of the first housing 110 together with the plug socket 123. This section 130 of the first housing 110 also includes a part 131 of the front wall 111 of the first housing 110.

The section 130 movably mounted in the plug-in axis x relative to the first housing 110 is held in a pushed forward position relative to the stationary first housing 110 by means of the spring element or actuator 300. For this purpose, the spring element or actuator 300 engages with one end on the section 130 and with the other end on the stationary first housing 110. When the first plug half 100 is contacted with an incompatible second plug half 200, its contact pin 221 pushes the plug element 122 formed from section 130 and plug socket 123 into the first housing 110 along the plug-in axis x, thereby preventing damage to the plug socket 121 and the contact pin 223.

FIG. 4 shows a further, alternative embodiment in which the plug element 222 of the second housing 210 comprises not only a contact pin 223, but also a section 230 of the second housing 210 to which the contact pin 223 is attached. The section 230 of the second housing 210 also includes a part 231 of the front wall 211. The spring element or the actuator 300 is in an extended functional position without the presence of a second plug half 200, in which the part 231 is aligned with the remaining front wall 211.

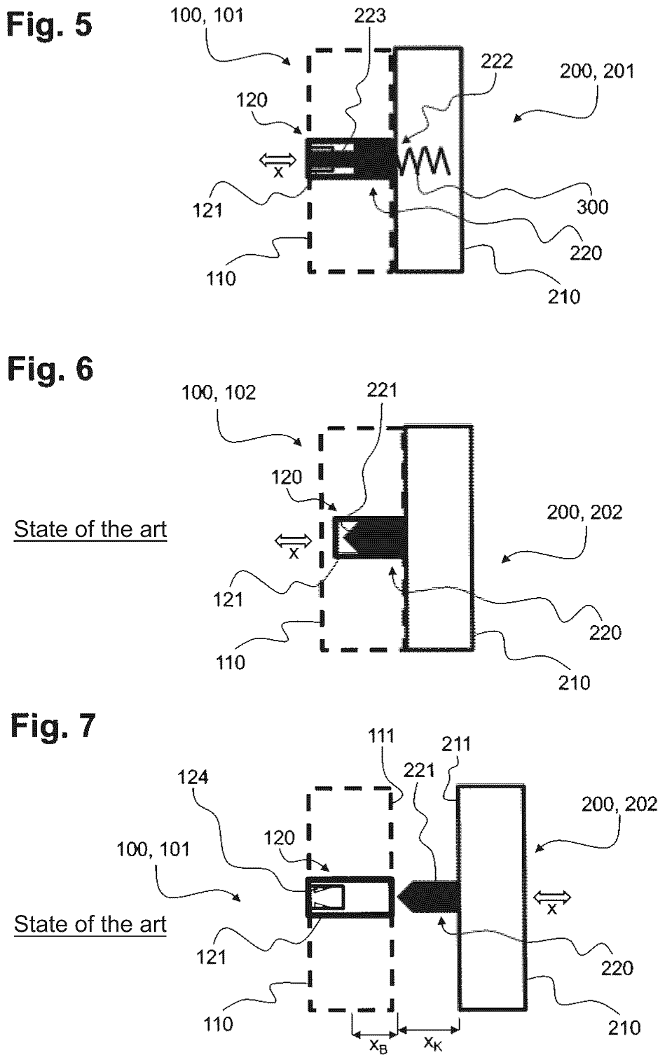

The other FIGS. 5 to 13 show different scenarios in which first and second plug halves 100, 200 of the same and different generations meet. For illustrative purposes, only one contact element 120 of the first housing 110 and one contact element 220 of the second housing 210 are shown as examples, even if in practice there are always several contact elements 120, 220 according to FIGS. 1 to 4.

FIG. 5 shows a meeting of a first plug half 100 in the form of a plug half 101 of the latest generation with a second plug half 200 in the form of a second plug half 201 of the same latest generation. The first and second plug halves 101, 201 slide into each other as they approach and thereby establish contact. The first and second plug halves 101, 201 provide the full range of functions.

The second plug half 201 has a plug element 222 that is movably mounted in the plug-in axis x, the associated contact pin 223 of which is pushed by the spring element or actuator 300 in an extended position in the direction of the first plug half 101. The movably mounted plug element 222 would be superfluous in this combination of the second plug half 201 of the latest generation with a first plug half 101 of the same latest generation.

FIG. 6 illustrates a situation in which a first plug half 100 in the form of a first plug half 102 of an older generation meets a second plug half 200 in the form of a second plug half 202 of an also older generation. The first and second plug halves 102, 202 correspond to the state of the art and offer the previous, limited range of functions of the known plug devices.

Naturally, neither the first plug half 100 nor the second plug half 200 has a contact element 120, 220 which is movably mounted in the plug element 122, 222 in the plug-in axis x relative to the first or second housing 110, 210.

However, problems can arise when the first and second plug halves 101, 102, 201, 202 according to the prior art are mixed from different generations. FIG. 7 addresses such a case.

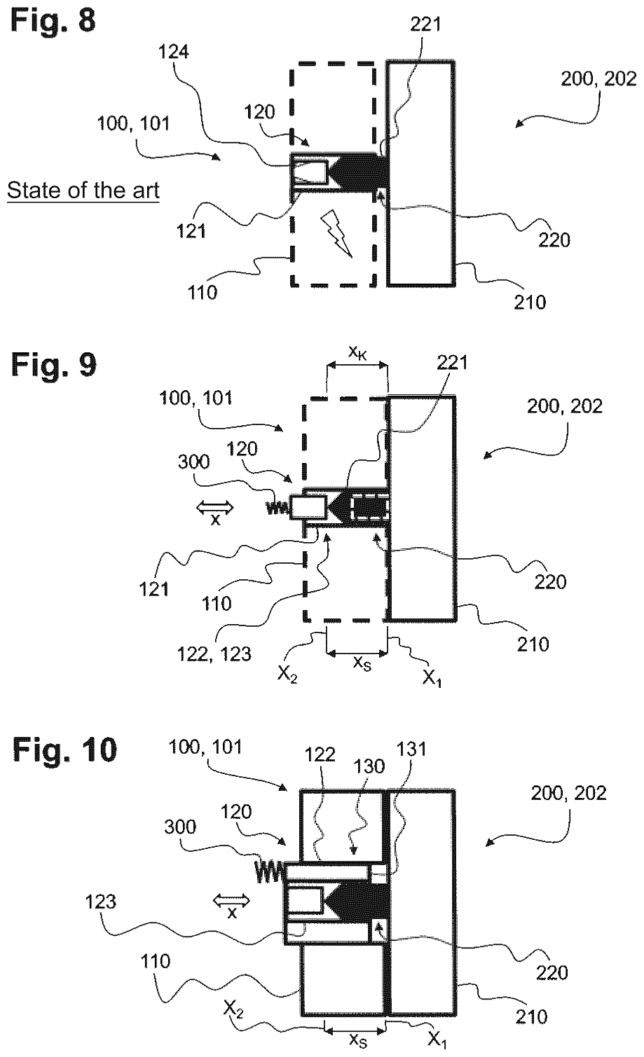

According to the illustration in FIG. 7, a first plug half 100 in the form of a plug half 101 of the latest generation approaches a second plug half 200 in the form of a plug half 202 of an older generation, but is not yet in operative contact with it. Neither the first nor the second plug half 101, 202 has a plug element 122, 222 that is movably mounted in the plug-in axis x. The contact pin 221 of the second plug half 202 is designed with a greater axial length x_{K} than the axial length x_{B} of the plug socket 121 of the first plug half 101, so that when the first plug half 101 comes closer to the second plug half 202, they collide with each other as shown in FIG. 8 and are thereby damaged.

A destructive collision of the plug socket 121 of the first plug half 101 with the contact pin 221 of the second plug half 202 is avoided by providing a plug element 122 on the first housing 110 as shown in the embodiment in FIG. 9, which allows its plug socket 123 to deviate in the plug-in axis x. Before contacting the contact pin 221, the plug socket 123 shown with a broken line is in the extended initial position x₁.

After contact with the contact pin 221, the latter has moved the plug socket 123 of the plug element 122 into a pushed-back yielding position x₂. The plug socket 123 has thus covered a travel path x_{S} as the plug element 122. The spring element or the actuator 300 is in a reversibly compressed position.

In the pushed-back yielding position x₂, there is still no functional connection between the plug socket 123 of the plug element 122 and the contact pin 221 of the second plug half 202; however, this would not be possible anyway due to the technically limited range of functions of the second plug half 202 according to the older generation.

FIG. 10 shows an alternative embodiment of a first plug half 101 of the latest generation with a plug element 122 movable along the plug-in axis x, on which plug element 122 a section 130 of the first housing 110 is also movably mounted together with the plug socket 123 und the section 130 has been pushed by the contact pin 221 partially penetrated into the plug socket 123 by the travel path x_{S} into the pushed-back yielding position x₂. The part 131 of the section 130 of the first housing 110 is also set back in steps relative to the front wall 111.

FIG. 11 shows the reverse case with a first plug half 100 in the form of a first plug half 102 according to an older generation, which meets a second plug half 200 in the form of a second plug half 201 according to the latest generation. In this embodiment, the second plug half 201 has a plug element 222 that is movably mounted along the plug-in axis x. The plug element 222 is formed here exclusively by the contact pin 223.

The contact pin 223 protrudes from the second housing 210 with an axial length x_{K} and already contacts the plug socket 121 with its distal end, which has a shorter axial length x_{B}.

At the distal end of the contact pin 223, one or more transmission means 224 are arranged set back in the axial direction and are thus protected from destruction by contact with the plug socket 121. The second housing 210 of the second plug half 201 is still aligned at a distance from the first housing 110 of the first plug half 102 in the plug-in axis x.

As the first and second plug halves 102, 201 approach further in accordance with the situation shown in FIG. 12, the contact pin 223 of the plug element 222 moves further into the second housing 210 against the pressure of the spring element or actuator 300 by the amount of the travel path x_{S} until the first and second plug halves 102, 201 have reached their end position and any further contact elements 120, 220, not visible here, are functionally connected.

FIG. 13 illustrates, by means of a further embodiment, a plug element 222 which, in addition to the contact pin 223, also comprises a section 230 of the second housing 210 which is also pushed into the housing 210 after contacting the contact pin 223 against the pressure of the spring element or actuator 300. This section 230 also includes a part 231 of the front wall 211.

### LIST OF REFERENCE NUMERALS

100 first plug half
101 first plug half, latest generation
102 first plug half, older generation
110 first housing
111 front wall, first housing
120 contact elements, first housing
121 plug sockets
122 plug element, first housing
123 plug socket, plug element
124 transmission means, plug socket
130 section, first housing
131 part, front wall, first housing
200 second plug half
201 second plug half, latest generation
202 second plug half, older generation
210 second housing
211 front wall, second housing
220 contact elements, second housing
221 contact pins
222 plug element, second housing
223 contact pin, plug element
224 transmission means, contact pin
230 section, second housing
231 part, front wall, second housing
300 Spring element/actuator
x plug-in axis
x₁ extended initial position of plug element
x₂pushed-back yielding position of plug element
x_{B} length of socket
x_{K} length of contact pin
x_{S} travel path of plug element

What is claimed is:

1. A plug device for a plug-type coupling system between a first vehicle and a second vehicle, wherein the plug device has a first plug half which is paired with the first vehicle and which comprises a first housing and a plurality of contact elements arranged in the first housing, and a second plug half which is paired with the second vehicle and which comprises a second housing and a plurality of contact elements arranged in the second housing, wherein the contact elements on the first plug half are plug sockets and the contact elements of the second plug half are contact pins which contact the plug sockets when the first and second plug halves are brought together in a plug-in axis (x),
wherein at least one contact element is fitted in a plug element which is movably mounted in the plug-in axis (x) with respect to the corresponding first or second housing
wherein the plug element is provided in such a way that, in the case of a collision of the first or second plug half with components of another, geometrically incompatible second or first plug half the plug element is arranged such that it can yield in the plug-in axis (x) counter to the plug-in direction and releases an assembly space, into which a portion of the other, incompatible second or first plug half can enter, wherein the plug element is oriented reversibly in a pushed-back yielding position (x₂) without a connection of the contact elements.

2. The plug device according to claim 1, wherein the plug element is guided linearly with respect to the associated first or second housing.

3. The plug device according to claim 1, wherein the plug element is a section of the first or second housing

4. The plug device according to claim 3, wherein the section of the first or second housing is formed from a part of the front wall facing the other second or first housing.

5. The plug device according to claim 3, wherein the contact element is arranged in a fixed position relative to the section of the associated first or second housing.

6. The plug device according to claim 3, wherein one plug socket of the plurality of plug sockets is fastened to the section of the associated first housing.

7. The plug device according to claim 1, wherein the plug element is one plug socket of the plurality of plug sockets.

8. The plug device according to claim 6, wherein the one plug socket of the plug element is arranged such that it is opposite the contact pin that protrudes furthest in the plug-in axis (x).

9. The plug device according to claim 3, wherein one contact pin of the plurality of contact pins is fastened to the section of the associated second housing.

10. The plug device according to claim 1, wherein the plug element is one contact pin of the plurality of contact pins

11. The plug device according to claim 9, wherein the one contact pin of the plug segment is dimensioned in the plug-in axis (x) such that it protrudes the furthest from the second plug half.

12. The plug device according to claim 1, wherein the plug element is held in an extended initial position (x₁) by means of a spring element or actuator.

13. The plug device according to claim 12, wherein the spring element or actuator transmits a preload force to the plug element that is greater than a plug resistance of a compatible contact element of the other first or second plug half.

14. The plug device according to claim 1, wherein the plug element is arranged in the first plug half and is pressed into a pushed-back yielding position by an incompatible second plug half upon contact with the latter.

15. The plug device according to claim 1, wherein the plug element is arranged in the second plug half and is pressed into a pushed-back yielding position (x₂) by an incompatible first plug half upon contact with the latter.

16. The plug device according to claim 1, wherein the plug element of the first plug half has a travel path (x_{S}) between an extended initial position (x₁) and a pushed-back yielding position (x₂) which corresponds to at least a difference between a length (x_{K}) of the associated contact pin of the second plug half protruding from the second housing and a length of the associated plug socket of the plug element of the first plug half protruding into the first housing in its extended initial position.

17. The plug device according to claim 1, wherein the plug element of the second plug half has a travel path (x_{S}) between an extended initial position (x₁) and a pushed-back yielding position (x₂) which corresponds to at least a difference between the length (x_{B}) of the associated plug socket of the first plug half projecting into the first housing and a length (x_{K}) of the associated contact pin of the plug element of the second plug half projecting from the second housing in its extended initial position.

18. The plug device according to claim 1, wherein the plug socket or the contact pin of the plug element have transmission means which are arranged in and transversely to the plug-in axis (x) outside a joint zone with the contact elements of the other, second or first housing.

19. The plug device according to claim 2, wherein the plug element is a section of the first or second housing, wherein the section of the first or second housing is formed from a part of the front wall facing the other second or first housing, wherein the contact element is arranged in a fixed position relative to the section of the associated first or second housing, and wherein one plug socket of the plurality of plug sockets is fastened to the section of the associated first housing.

20. The plug device according to claim 2, wherein the plug element of the first plug half has a travel path (x_{S}) between an extended initial position (x₁) and a pushed-back yielding position (x₂) which corresponds to at least a difference between a length (x_{K}) of the associated contact pin of the second plug half protruding from the second housing and a length (x_{B}) of the associated plug socket of the plug element of the first plug half protruding into the first housing in its extended initial position (x₂), wherein the plug element of the second plug half has a travel path (x_{S}) between an extended initial position (x₁) and a pushed-back yielding position (x₂) which corresponds to at least a difference between the length (x_{B}) of the associated plug socket of the first plug half projecting into the first housing and a length (x_{K}) of the associated contact pin of the plug element of the second plug half projecting from the second housing in its extended initial position (x₁), and wherein the plug socket or the contact pin of the plug element have transmission means which are arranged in and transversely to the plug-in axis (x) outside a joint zone with the contact elements of the other, second or first housing.
